(19) United States
(12) Patent Application Publication
(10) Pub. No.: US 2002/0044605 A1
(43) Pub. Date: Apr. 18, 2002

(54) Video signal encoder and video signal encoding method

(75) Inventor: Takeshi Nakamura, Tsurugashima-shi (JP)

Correspondence Address: MORGAN, LEWIS & BOCKIUS, 1800 M STREET NW, WASHINGTON, DC, 20036-5869, US

(73) Assignee: PIONEER CORPORATION

(21) Appl. No.: 09/951,437

(22) Filed: Sep. 14, 2001

(30) Foreign Application Priority Data
Sep. 14, 2000 (JP) P2000-280367

(51) Int. Cl. H04B 1/66; H04N 7/12; H04N 11/02; H04N 11/04

(52) U.S. Cl. 375/240.04; 375/240.05; 375/240.24; 375/240.03; 375/240.12

(57) ABSTRACT

An MPEG encoder for encoding an input digital video signal performs encoding processing in every macroblock forming a picture by a frame sequence changing unit, a motion detecting unit, a subtracting unit, a discrete cosine transform unit, a quantization unit, a variable-length coding unit, an inverse quantization unit, an inverse discrete cosine transfer unit, an adding unit, a frame storing and predicting unit, a multiplexer, and a buffer memory. The encoder further decides a quantization scale for every macroblock by a quantization deciding unit by use of the picture target encode amount calculated in an assigned encode amount calculating unit and the encoded amount obtained in an encoded amount calculating unit, and thereafter controls the quantization scale to be corrected into a direction of decreasing a deviation degree of the encoded amount from the target encode amount by a quantization correcting unit.

### BACKGROUND OF THE INVENTION

1. Field of the Invention

The present invention relates to a video signal encoding apparatus and method for encoding a video signal, and more particularly to a technical field of an MPEG encoding apparatus and method for creating encode data after performing variable-length encoding on the input video signal while controlling a quantization scale for the input video signal.

2 Description of the Related Art

The MPEG (Moving Picture Expert Group) encoding method is recently in widespread use as the standard data compression method for a video signal, The MPEG encoding method is to perform variable-length encoding on an input video signal and the encoded amount always varies on the complexity of an image. Therefore, in the encoding processing of the MPEG encoding method, a rate control is performed depending on a predetermined target encode amount and the actually-encoded amount is controlled to agree with the target encode amount while controlling a quantization scale which determines the width of quantization of the encode data in a variable way.

When executing the above-mentioned variable-length encoding processing, the MPEG encoding method divides a video signal entered by the unit of picture into 16×16 pixels macroblock and quantizes it in every macroblock by the use of the above quantization scale. However, there may be the case where the encoded amount of each macroblock doesn't agree with the predetermined target encode amount, hence to accumulate each error. That may induce the case where the total encoded amount of the I-picture is too much or too less. As a result, the encode amount of the following pictures is constrained because of the constrained VBV buffer, thereby deteriorating the image quality due to fluctuation of the encode amount.

### SUMMARY OF THE INVENTION

In consideration of the above problem, the present invention aims to provide a video signal encoder and a video signal encoding method capable of controlling the encode amount stably without deteriorating the image quality, by correcting a quantization scale for a picture corresponding to a video signal by the unit of macroblock and conforming the encoded amount in the encoding processing with the target encode amount.

The above object of the present invention can be achieved by a video signal encoder of the present invention for performing variable-length encoding processing on an input video signal and supplying the created encode data. The encoder is provided with a block unit setting device for setting a target encode amount and a quantization scale in the above encoding processing for every unit of block that is an encode unit for the video signal; a correcting device for calculating an encoded amount when encoding the unit of block, monitoring how much degree transition of the encoded amount is deviated from transition of the target encode amount, and correcting the quantization scale into a direction of decreasing the deviation degree, and a block unit quantization device for performing quantization for every unit of block by use of the corrected quantization scale and creating the encode data.

According to the present invention, a target encode amount and a quantization scale is set on an input video signal in every unit of block, the transition of the target encode amount is required. Then, a deviation degree of the transition of the encoded amount generated in the actual encoding processing from the transition of the target encode amount is monitored. Further, the quantization scale is sequentially corrected in a direction of decreasing the deviation degree. Then, the quantization is performed in every unit of block by use of the corrected quantization scale. Further, the encode data is created and supplied. Therefore, when the encoded amount is deviated from the target encode amount, the quantization scale can be controlled to be gently corrected in every unit of block, thereby preventing such a situation that each error of the encoded amounts accumulates, previously. Therefore, the present invention can realize the encoding processing capable of controlling the encoded amount stably while keeping an image even.

In one aspect of the present invention, the video signal is entered by a picture including a plurality of the units of blocks, a picture setting device for setting a picture quantization scale as a quantization scale for every picture, and said correcting device decides a correction amount for a quantization scale for every unit of block, depending on the picture quantization scale.

According to this aspect, after a picture quantization scale is set on a video signal entered by a picture, correction of the quantization scale is performed in every unit of block as mentioned above and the correction amount at that time is decided depending on the picture quantization scale. Therefore, since the correction amount is decided with reference to a picture that is the data unit larger than the unit of block when the quantization scale is corrected in every unit of block, the present invention can control the encoded amount more stably by use of the correction amount of high reliability.

In another aspect of the present invention, said picture setting device sets a picture target encode amount as the target encode amount for every picture, in addition to the picture quantization scale, and said block unit setting device sets the target encode amount for every unit of block based on the picture target encode amount.

According to this aspect, after a picture target encoded amount and a picture quantization scale are set on a video signal entered by the picture, the target encode amount for every unit of block is set based on 1the picture target encode amount, and by use of this, the above correction is performed. Therefore, both the target encode amount and the quantization scale for every unit of block are decided with reference t5 to a picture that is the data unit larger than the unit of block, thereby realizing the stable and reliable encoding processing.

In further aspect of the present invention, said correcting device calculates a parameter indicating a degree of deviating the transition of the encoded amount from the transition of the target encode amount, compares a predetermined threshold with the parameter, and decides the correction amount for the quantization scale depending on the comparison result.

According to this aspect, when the quantization scale is corrected in every unit of block as mentioned above, a deviation degree of the encoded amount is calculated as a parameter, and the correction amount of the quantization scale is decided by comparison between the parameter and the predetermined threshold. Therefore, a deviation 4 degree of the encoded amount from the target encode amount can be easily set within a constant range by setting the threshold, thereby properly controlling the correction of the quantization scale depending on a situation of an image quality and the like.

In further aspect of the present invention, said correcting device does not perform the correction on the quantization scale when the absolute value of the parameter does not exceed the threshold.

According to this aspect, the parameter is compared with the predetermined threshold, and whether or not to perform the correction on the quantization scale is decided by comparison between the absolute value of the parameter and the predetermined threshold. Therefore, when the encoded amount varies near along the target encode amount, since the present invention can keep the situation, it can control the correction only in the case of necessity while keeping the original quantization scale, thereby keeping the encode amount stable without deteriorating an image by excessive correction.

The above object of the present invention can be achieved by a video signal encoding method for performing variable-length encoding processing on an input video signal and supplying the created encode data, the method comprising the processes of: setting a target encode amount and a quantization scale in the encoding processing for every unit of block that is an encode unit for the video signal; calculating an encoded amount when encoding the unit of block; monitoring how much degree transition of the encoded amount is deviated from transition of the target encode amount; correcting the quantization scale into a direction of decreasing the deviation degree; and performing quantization for every unit of block by use of the corrected quantization scale and creating the encode data.

According to the present invention, a target encode amount and a quantization scale is set on an input video signal in every unit of block, the transition of the target encode amount is required. Then, a deviation degree of the transition of the encoded amount generated in the actual encoding processing from the transition of the target encode amount is monitored. Further, the quantization scale is sequentially corrected in a direction of decreasing the deviation degree. Then, the quantization is performed in every unit of block by use of the corrected quantization scale, Further, the encode data is created and supplied. Therefore, when the encoded amount is deviated from the target encode amount, the quantization scale can be controlled to be gently corrected in every unit of block, thereby preventing such a situation that each error of the encoded amounts accumulates, previously. Therefore, the present invention can realize the encoding processing capable of controlling the encoded amount stably while keeping an image even.

In one aspect of the present invention, the video signal is entered by a picture including a plurality of the units of block, the method further comprises the process of setting a picture quantization scale as a quantization scale for every picture, and in said process of correcting the quantization scale, a correction amount for a quantization scale for every unit of block is decided depending on the picture quantization scale.

According to this aspect, after a picture quantization scale is set on a video signal entered by the picture, correction of the quantization scale is performed in every unit of block as mentioned above and the correction amount at that time is decided depending on the picture quantization scale. Therefore, since the correction amount is decided with reference to a picture that is the data unit larger than the unit of block when the quantization scale is corrected in every unit of block, the present invention can control the encoded amount more stably by use of the correction amount of high reliability.

In another aspect of the present invention, in said process of setting a picture quantization scale, a picture target encode amount is set as the target encode amount for every picture, in addition to the picture quantization scale, and in said process of setting a target encode amount and a quantization scale, the target encode amount for every block unit is set based on the picture target encode amount.

According to this aspect, after a picture target encoded amount and a picture quantization scale are set on a video signal entered by the picture, the target encode amount for every unit of block is set based on the picture target encode amount, and by use of this, the above correction is performed. Therefore, both the target encode amount and the quantization scale for every unit of block are decided with reference to a picture that is the data unit larger than the unit of block, thereby realizing the stable and reliable encoding processing.

In further aspect of the present invention, in said process of correcting the quantization scale, a parameter indicating a degree of deviating the transition of the encoded amount from the transition of the target encode amount is calculated, the parameter is compared with a predetermined threshold, and the correction amount for the quantization scale is decided depending on the comparison result.

According to this aspect, when the quantization scale is corrected in every unit of block as mentioned above, a deviation degree of the encoded amount is calculated as a parameter, and the correction amount of the quantization scale is decided by comparison between the parameter and the predetermined threshold. Therefore, a deviation degree of the encoded amount from the target encode amount can be easily set within a constant range by setting the threshold, thereby properly controlling the correction of the quantization scale depending on a situation of an image quality and the like.

In further aspect of the present invention, in said process of correcting the quantization scale, correction is not performed on the quantization scale when the absolute value of the parameter does not exceed the threshold.

According to this aspect, the parameter is compared with the predetermined threshold, and whether or not to perform the correction on the quantization scale is decided by comparison between the absolute value of the parameter and the predetermined threshold. Therefore, when the encoded amount varies near along the target encode amount, since the present invention can keep the situation, it can control the correction only in the case of necessity while keeping the original quantization scale, thereby keeping the encode amount stable without deteriorating an image by excessive correction.

### BRIEF DESCRIPTION OF THE DAWINGS

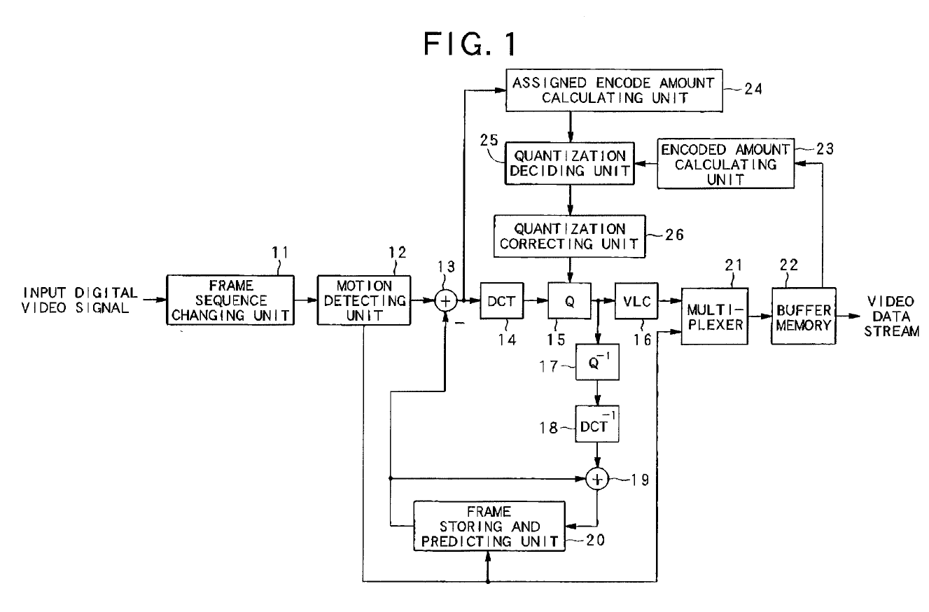

FIG. 1 is a block diagram showing the overall structure of an MPEG encoder according to an embodiment of the present invention,

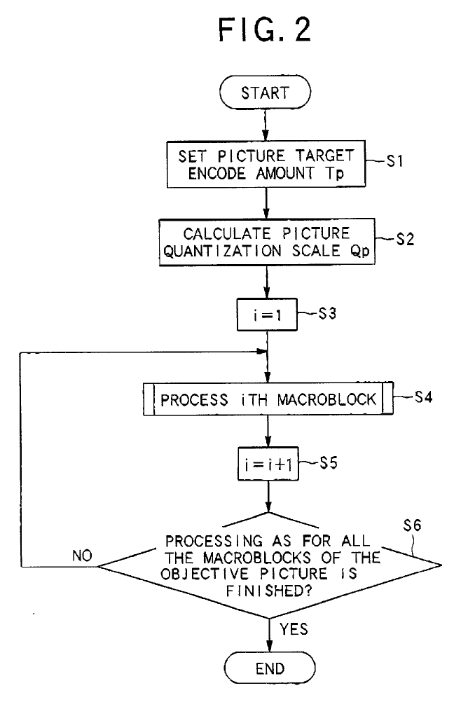

FIG. 2 is a flow chart showing the overall processing of deciding a quantization scale in the embodiment;

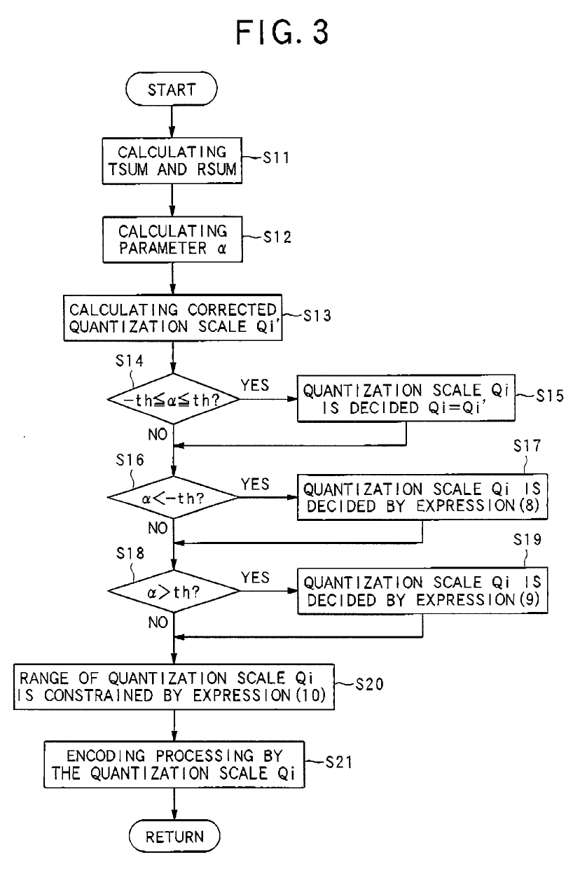

FIG. 3 is a flow chart showing the processing for each macroblock in the processing of deciding a quantization scale in the embodiment;

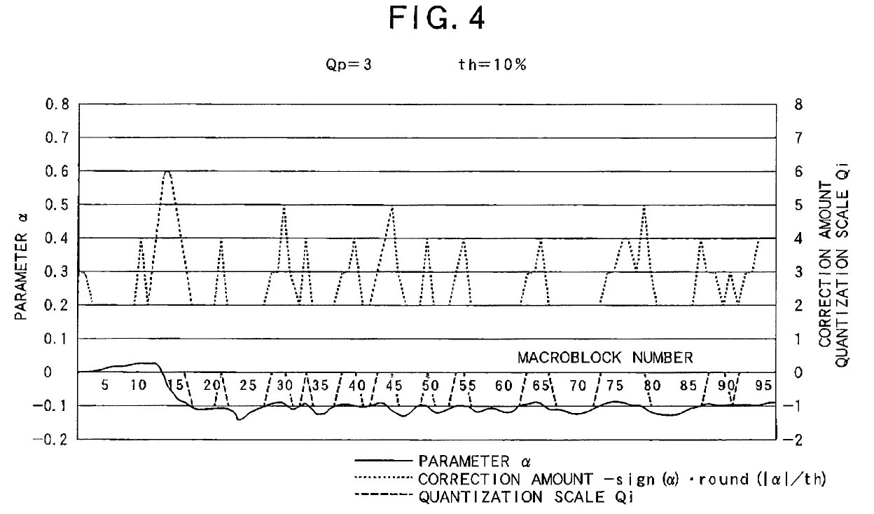

FIG. 4 is a characteristic graph showing the actual effect by the processing of deciding a quantization scale in the embodiment; and

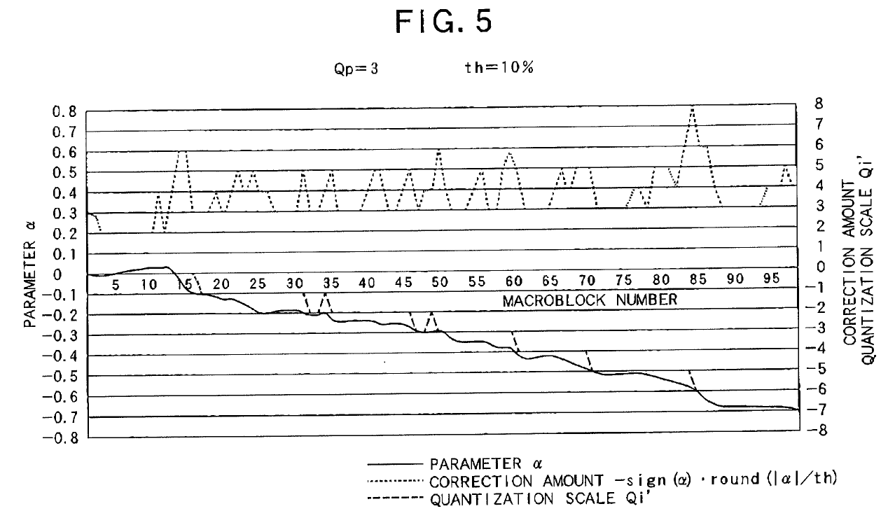

FIG. 5 is a characteristic graph by a conventional graph for comparison to FIG. 4.

### DESCRIPTION OF THE PREFERRED EMBODIMENT

Hereinafter, a preferred embodiment of the present invention will be described with reference to the drawings. The embodiment will be described here in the case where the present invention is adopted to an MPEG encoder for outputting a video data stream after encoding an input digital video signal according to the MPEG method.

FIG. 1 is a block diagram showing the overall structure of the MPEG encoder according to the embodiment, The MPEG encoder shown in FIG. 1 is provided with a frame sequence changing unit 11, a motion detecting unit 12, a subtracting unit 13, a discrete cosine transform unit (DCT: Discrete Cosine Transform) 14, a quantization unit (Q: Quantization) 15, a variable length coding unit (VLC—Variable Length Coding) 16, an inverse quantization unit (Q⁻¹) 17, an inverse discrete cosine transform unit (DCT⁻¹) 18, an adding unit 19, a frame storing and predicting unit 20, a multiplexer 21, a buffer memory 22, an encoded amount calculating unit 23, an assigned encode amount calculating unit 24, a quantization deciding unit 25, and a quantization correcting unit 26.

In the above structure, the frame sequence changing unit 11 properly changes a sequence of the encoding processing depending on the picture type forming the input digital video signal. In other words, since a method of the processing by use of the future frame or the past frame depends on whether each frame belongs to I picture, P picture, or B picture, it is necessary to rearrange the sequence of the processing.

The motion detecting unit 12 detects a motion vector after performing pattern matching in every region by the unit of 16×16 pixels macroblock in an image frame, and supplies a frame image signal The subtraction unit 13 subtracts a prediction signal outputted by the frame storing and predicting unit 20 from a frame image signal outputted by the motion detecting unit 12 and supplies the obtained subtraction signal to the discrete cosine transform unit 14.

The discrete cosine transform unit 14 performs two-dimensional discrete cosine transform on the subtraction signal from the subtraction unit 13 in every 8×8 pixels block and supplies the created transform signal to the quantization unit 15. The quantization unit 15 quantizes the transform signal from the discrete cosine transform unit 14 by use of a quantization scale corrected by the quantization correcting unit 26 and supplies the created quantization signal to the variable length coding unit 16 and the inverse quantization unit 17.

In the embodiment, the quantization scale for use in the quantization is established at an integer within the range from the minimum value Q min to the maximum value Q max and the quantization signal created by the quantization unit 15 has a level inversely proportional to the quantization scale. The variable range defined by the Qmin and Qmax in the quantization scale is classified into, for example, 31 stages from Qmin=1 to Qmax=31.

The inverse quantization unit 17 inversely quantizes the quantization signal from the quantization unit 15, creates an inverse quantization signal, and supplies it to the inverse discrete cosine transform unit 18. The inverse discrete cosine transform unit 18 performs the inverse discrete cosine transform on the inverse quantization signal from the inverse quantization unit 17 and supplies the created inverse transform signal to the adding unit 19.

The adding unit 19 adds a prediction signal form the frame storing and predicting unit 20 to the inverse quantization signal from the inverse quantization unit 17 and supplies the obtained add signal to the frame storing and predicting unit 20. The frame storing and predicting unit 20 stores the add signal from the adding unit 19 for one frame, predicts a fluctuation in the following frame based on the motion vector detected by the motion detecting unit 12 with reference to the stored add signal, and supplies it to the subtracting unit 13 and the adding unit 19 as a prediction signal.

The variable length coding unit 16 performs the variable-length encoding processing on the quantization signal from the quantization unit 15 by the unit of macroblock, hence to create a variable length encoded signal. The created variable length encoded signal is supplied to the multiplexer 21. The buffer memory 22 receives the variable length encoded signal through the multiplexer 21 and also receives the motion vector from the motion detecting unit 12, so to store the data temporarily. The data stored in the buffer memory 22 is supplied outwardly as a video data stream at a predetermined timing.

On the other hand, the variable length encoded signal stored in the buffer memory 22 is supplied to the encoded amount calculating unit 23. The encoded amount calculating unit 23 requires the amount actually encoded as the result of the MPEG encoding processing and supplies the encoded amount for every macroblock to the quantization deciding unit 25.

The subtraction signal from the subtracting unit 13 is supplied to the assigned encode amount calculating unit 24. The assigned encode amount calculating unit 24 calculates the index of image complexity of a frame image based on the subtraction signal, calculates the encode amount to be assigned to each picture based on the obtained image complexity index, and supplies the calculation result for every picture to the quantization deciding unit 25 as a picture target encode amount.

The quantization deciding unit 25 decides a quantization scale for every macroblock according to the following existing method, by use of the encoded amount obtained in the encoded amount calculating unit 23 and the picture target encode amount calculated in the assigned encode amount calculating unit 24. The quantization correcting unit 26 performs the correction processing according to the present invention as described later on the quantization scale decided in the quantization deciding unit 25 and supplies the corrected quantization scale to the quantization unit 15.

In the MPEG encoder according to the present embodiment, the processing of deciding a quantization scale performed mainly by the quantization deciding unit 25 and the quantization correcting unit 26 will be described with reference to FIG. 2 to FIG. 5.

FIG. 2 is a flow chart showing the overall processing of deciding a quantization scale according to the embodiment. Hereinafter, a description will be made assuming that one picture is formed by N pieces of macroblocks in total.

As illustrated in FIG. 2, when the processing for a predetermined picture in the MPEG encoder starts, the target encode amount Tp as for the picture to be processed is defined (Step S1). More specifically, the picture target encode amount Tp is the target encode amount (bit unit) to be assigned to the corresponding picture, and a proper value corresponding to the state of a rate control and the picture type in the MPEG encoder is defined.

The picture quantization scale Qp to be set for the objective picture is calculated (Step S2). The picture quantization scale Qp is to give a start point in deciding a quantization scale of any macroblock described later. The following relational expression by use of the picture target encode amount Tp is assumed in the rate control in every picture in the MPEG encoder:

Tp=X₁·Sp/Qp+X₂·Sp/Qp² (1)

wherein Sp denotes an index of image complexity of a picture, and X₁ and X₂ denote predetermined parameters,

In the expression (1), the image complexity index Sp of a picture is calculated in the assigned encode amount calculating unit 24 as mentioned above. More concretely, variance or absolute sum of each image data is required based on the subtraction signal corresponding to the difference of frame images and this can be used as the image complexity index Sp.

Accordingly, the picture quantization scale Qp can be obtained from the expression (1) by using the picture target encode amount Tp and the image complexity index Sp of a picture obtained as described above. The parameters X₁ and X₂ in the expression (₁) must be set at each preferable value in the MPEG encoder.

A counter i for macroblock is set at 1 (Step S3). The counter i varies from 1 to N so as to count each macroblock under processing in the objective picture. The reference numbers are attached to N pieces of macroblocks included in one picture in the order of raster scanning (from left to right, from top to bottom) according to the position of each image.

The processing for deciding a quantization scale will be sequentially performed from an ith macroblock (Step S4). The processing of Step S4 will be described by using FIG. 3 more concretely.

FIG. 3 is a flow chart showing the processing of deciding a quantization scale Q₁ of the ith macroblock. The total of the target encode amount, Tsum, and the total of the encoded amount, Rsum, are calculated (Step S11). The Tsum indicates the total of the target encoded amount in the macroblocks having been processed in the objective picture and the Rsum indicates the total of the encoded amount in the macroblocks having been processed in the objective picture. In the ith macroblock, it is necessary to use the Tsum and the Rsum as for the sum of the first macroblock to the previous (i-1)th macroblock, and they are respectively represented as Tsumⁱ⁻¹ and Rsumᵢ₋₁. 14

For the first macroblock (i=1), it is set that Tsum=Rsum=0, and Tsumᵢ₋₁ and Rsumᵢ₋₁ as for the second and later macroblocks (i≧2) are calculated according to the expressions (2) and (3):

Tsumᵢ₋₁=T₁+T₂+. . . +Tᵢ₋₁=Tsumᵢ₋₂+Tᵢ₋₁ (2)

wherein Tⱼ denotes a target encode amount of a jth (1 to (i−1)th) macroblock;

Rsumᵢ₋₁=R₁+R₂+. . . +Rᵢ₋₁=Rsumᵢ₋₂+Rᵢ₋₁ (3)

wherein Rj denotes an encoded amount of the jth (1 to (i−1)th) macroblock.

Here, the above Tⱼ is the target encode amount in encoding the jth macroblock corresponding to the picture target encode amount set in Step S1, and it is calculated in the following expression:

Tⱼ=Tp·Sⱼ/Sp (4)

wherein Sp=S₁+S₂+. . . +S_{N}(Sᵢ: the image complexity index of the ith macroblock).

As illustrated in the expression (4), the target encode amount of each macroblock can be calculated from the picture target encode amount Tp and the picture image complexity index Sp. Here, it is found that the picture image complexity index Sp is represented by the total of the image complexity index Sᵢ for every macroblock within one picture and that the target encode amount Ti of a macroblock is distributed in proportion to the image complexity index S₁ according to the expression (4).

Since the above Rᵢ₋₁ is the encode amount actually generated in the last encoding processing in the MPEG encoder, it can be distinguished easily in the encoded amount calculating unit 23.

Next, a parameter a for representing the proportion of the target encode amount and the encoded amount predicted as for the ith macroblock. The parameter a is defined by use of the Tsumᵢ₋₁ and Rsumᵢ₋₁ calculated in the above according to the following expression (Step S12):

$$\begin{matrix}α = \{ ( {Rsum}_{i - 1} + {T}_{i} ) - ( {Tsum}_{i - 1} + {T}_{i} ) \} / Tp \\ = ( {Rsum}_{i - 1} - {Tsum}_{i - 1} ) / Tp\end{matrix} \qquad ( 5 )$$

The parameter α is a parameter for checking how much degree the total amount of the predicted encoded amount is deviated from the target encode amount at a time of processing the ith macroblock. More specifically, as illustrated in the expression (5), when the transition of the encoded amount in every macroblock agrees with the transition of the target encode amount in the objective picture, the parameter a approaches to zero. While, according as the transition of the encoded amount in every macroblock is more deviated from the transition of the target encode amount, the parameter α is changing toward the positive or negative direction.

A quantization scale Qᵢ' as for the ith macroblock before correction in the quantization correcting unit 26 is calculated in the quantization deciding unit 25 (Step S13). More specifically, the quantization scale Qᵢ' can be required according to the following two relational expressions, by using the existing method:

Rᵢ=A₁·Sᵢ/Qᵢ'² (6)

Rᵢ=A₂·Sᵢ/Qᵢ'²+A₃Sᵢ/Qᵢ' (7)

wherein A₁, A₂, and A₃ denote predetermined parameters.

The expression (6) or the expression (7) may be used depending on the size of the target bit rate in the MPEG encoder. Preferably, when the target bit rate is large, the expression (6) is used, while when the target bit rate is small, the expression (7) is used Therefore, it is necessary to set a predetermined threshold and decide which expression to be used, according to a comparison between the threshold and the target bit rate.

In the quantization correcting unit 26, the correction processing will be performed on the quantization scale Qi' obtained in the above, according to the parameter a calculated in Step S12, in the following procedure. In order to check the value of the parameter α, it is necessary to set a threshold th in advance, and this can be adopted to decide the degree of correction in the quantization correcting unit 26 properly. For example, when it is set as th=0.1 (10%), the following correction will be performed if the parameter α is deviated from the range

−0.1 to +0.1.

When the deviation of the parameter α is small and the parameter α proves to satisfy the condition −th≦α≦th (YES; Step S14), no correction is performed on the quantization scale Qᵢ' and the quantization scale Qᵢ after correction is decided as Qᵢ=Qᵢ' (step S15).

When the parameter α is deviated in the negative direction and it proves to satisfy α<−th (YES; Step S16), the quantization scale Qᵢ' is corrected by using the following expression (8) and the quantization scale Qᵢ after correction is decided (Step S17):

Qᵢ=min(Qᵢ', Qp-round(−α/th)) (8)

wherein min(a, b) denotes an operation for selecting the smaller one of a and b, and round (x) denotes an operation for dropping the fractional portion of the number x

Here, when the parameter a is negative, it is found that the encoded amount is shorter than the target encode amount. Accordingly, in order to solve the above state, correction to decrease the quantization scale Qᵢ by use of the expression (8) can change the encoded amount contrarily into an increasing direction.

When the parameter a is deviated in the positive direction and it proves to satisfy α>th (YES; Step S18), the quantization scale Qᵢ' is corrected by using the following expression (9) and the quantization scale Qᵢ after correction is decided (Step S19):

Qᵢ=max(Qᵢ', Qp+round(α/th)) (9)

wherein max(a, b) denotes an operation for selecting the larger one of a and b.

Here, when the parameter α is positive, it is found that the encoded amount is beyond the target encode amount. Accordingly, in order to solve the above state, correction to increase the quantization scale Qᵢ by use of the expression (9) can change the encoded amount contrarily into a decreasing direction.

A range as for the quantization scale Qᵢ decided according to the above Step S14 to Step S19 is constrained by the following expression (10) (Step S20):

Qᵢ=CkRange(Qᵢ, Qmin, Qmax) (10)

wherein CkRange(x, a, b) denotes an operation of selecting a when x<a, selecting b when x>b, and selecting x in the other case. 18

Thus, the constraint of the range in Step S20 is the processing for preventing the quantization scale Qᵢ deviating from the range, provided that the quantization scale Qᵢ becomes below the range in Step S17 or beyond the range in Step S19 after the above correction.

The encoding processing by use of the quantization scale Qᵢ finally decided through Step S13 to Step S20 is performed (Step 21) and video data of the ith macroblock is output based on the created quantization signal.

Back to FIG-2, since the processing for one macroblock is finished in Step S4, 1 is added to the counter i for macroblock (Step S5), and when the processing for all the macroblocks included in the objective picture is finished (YES; Step S6), the processing of FIG. 2 is finished. While, when a macroblock which has not been processed is left (NO; Step S6), the processing is returned to Step S4, where the processing thereafter will be repeated.

The actual effect in the above-mentioned processing of deciding a quantization scale, in the MPEG encoder according to the embodiment, will be described by using FIG, 4 and FIG. 5. FIG. 4 is a graph showing the transition of characteristic in the case of adopting the above method under a predetermined condition, and FIG. 5 is a graph showing the transition of characteristic in the case of adopting the conventional method instead of the above method for a comparison to FIG. 4.

In FIG. 4 and FIG. 5, assume that the picture quantization scale Qp is set at 3 and that the threshold th is set at 10% (=0.1) when the MPEG encoder encodes a predetermined picture. The change in characteristic in the case of sequential encoding in every macroblock within one picture, under these circumstances, is shown for comparison between FIG. 4 and FIG. 5.

FIG. 4 is a graph which plots each characteristic as for the following three items, when the correction processing according to the present invention is performed in the MPEG encoder, according to the number of the macroblocks in the horizontal axis.

parameter α

correction amount -sign(α)·round(|α|/th) in the expression (8) or the expression (9)

wherein sign(α)=1(α≧0), −1(α<0)

quantization scale Qᵢ

While, FIG. 5 is a graph which plots each characteristic as for the three items of the quantization scale Qi' before the correction in addition to the above correction amount and the same parameter a as in FIG. 4, when the above correction processing is not performed.

In the graph shown in FIG. 4, the encoded amount varies smaller than the target encode amount and the parameter α calculated in every macroblock substantially becomes negative. Therefore, “YES” is frequently selected in Step S16 and the quantization scale Qᵢ corrected by the expression (8) is to be obtained, Since the parameter a varies around −0.1 and the threshold th is 0.1, the correction amount -sign(α)·round(|α|/th) according to the expression (8) becomes 0 or 1. The correction amount is fed back to the quantization scale Qᵢ, which results in preventing a large fluctuation of the parameter α.

On the contrary, in the graph shown in FIG. 5, though the encoded amount varies smaller than the target encode amount in the same way as in FIG. 4, the above correction processing is not performed, and therefore, the parameter a in FIG. 5 becomes larger and larger in the negative direction. According to the above parameter a, the correction amount -sign(α)·round(|α|/th) also becomes larger in the negative direction. The correction amount, however, is not fed back to the quantization scale Qᵢ'.

When requiring the ratio of the encoded amount and the target encode amount obtained in the I picture in FIG. 4 and in FIG. 5, the encoded amount/the target encode amount=95.6% in the case of FIG. 4, and the encoded amount/the target encode amount=66.2% in the case of FIG. 5. Thus, by applying the correction processing according to the present invention to the MPEG encoder, the transition of the encoded amount can be controlled to approach the target encode amount.

In the embodiment as mentioned above, the encoded amount substantially agrees with the target encode amount, thereby achieving stability of the encoded amount generated in the MPEG encoding method. When a quantization scale is corrected according to the expression (8) and the expression (9), according as the transition of the encoded amount is more deviated from the transition of the target encode amount, the quantization scale can be properly corrected by the larger correction amount. Further, the picture quantization scale and the picture target encode amount are required, and then the correction processing in every macroblock is performed using them. Therefore, the quantization scale of a macroblock can be decided with reference to the picture of the data size larger than the macroblock, thereby enhancing the reliability of the encoding processing. Additionally, since the correction in every macroblock advances slowly within the I-picture, the encoding processing can be prevented from becoming unstable due to a rapid fluctuation of the quantization scale.

In the above embodiment, although the description has been made in the case of applying the present invention to the MPEG encoder using the MPEG encoding method, the present invention can be applied to any encoding system other than this as far as it can set the target encode amount and the quantization scale for every block.

The invention may be embodied in other specific forms without departing from the spirit or essential characteristics thereof. The present embodiments are therefore to be considered in all respects as illustrative and not restrictive, the scope of the invention being indicated by the appended claims rather than by the forgoing description and all changes which come within the meaning and range of equivalency of the claims are therefore intended to be embraces therein.

The entire disclosure of Japanese Patent Application No, 2000-280367 filed on Sep. 14, 2000 including the specification, claims, drawings and summary is incorporated herein by reference in its entirety.

What is claimed is:

1. A video signal encoder for performing variable-length encoding processing on an input video signal and supplying the created encode data, comprising:
a block unit setting device for setting a target encode amount and a quantization scale in the above encoding processing for every unit of block that is an encode unit for the video signal;
a correcting device for calculating an encoded amount when encoding the unit of block, monitoring how much degree transition of the encoded amount is deviated from transition of the target encode amount, and correcting the quantization scale into a direction of decreasing the deviation degree; and
a block unit quantization device for performing quantization for every unit of block by use of the corrected quantization scale and creating the encode data.

2. The video signal encoder according to claim 1, wherein
the video signal is entered by a picture including a plurality of the units of blocks,
a picture setting device for setting a picture quantization scale as a quantization scale for every picture, and
said correcting device decides a correction amount for a quantization scale for every unit of block, depending on the picture quantization scale.

3. The video signal encoder according to claim 2, wherein
said picture setting device sets a picture target encode amount as the target encode amount for every picture, in addition to the picture quantization scale, and
said block unit setting device sets the target encode amount for every unit of block based on the picture target encode amount.

4. The video signal encoder according to claim 1, wherein
said correcting device calculates a parameter indicating a degree of deviating the transition of the encoded amount from the transition of the target encode amount, compares a predetermined threshold with the parameter, and decides the correction amount for the quantization scale depending on the comparison result.

5. The video signal encoder according to claim 4, wherein
said correcting device does not perform the correction on the quantization scale when the absolute value of the parameter does not exceed the threshold.

6. A video signal encoding method for performing variable-length encoding processing on an input video signal and supplying the created encode data, the method comprising the processes of:
setting a target encode amount and a quantization scale in the encoding processing for every unit of block that is an encode unit for the video signal;
calculating an encoded amount when encoding the unit of block;
monitoring how much degree transition of the encoded amount is deviated from transition of the target encode amount;
correcting the quantization scale into a direction of decreasing the deviation degree; and
performing quantization for every unit of block by use of the corrected quantization scale and creating the encode data.

7. The video signal encoding method according to claim 6, wherein
the video signal is entered by a picture including a plurality of the units of block,
the method further comprises the process of setting a picture quantization scale as a quantization scale for every picture, and
in said process of correcting the quantization scale, a correction amount for a quantization scale for every unit of block is decided depending on the picture quantization scale.

8. The video signal encoding method according to claim 7, wherein
in said process of setting a picture quantization scale, a picture target encode amount is set as the target encode amount for every picture, in addition to the picture quantization scale, and
in said process of setting a target encode amount and a quantization scale, the target encode amount for every block unit is set based on the picture target encode amount.

9. The video signal encoding method according to claim 6, wherein
in said process of correcting the quantization scale, a parameter indicating a degree of deviating the transition of the encoded amount from the transition of the target encode amount is calculated, the parameter is compared with a predetermined threshold, and the correction amount for the quantization scale is decided depending on the comparison result.

10. The video signal encoding method according to claim 9, wherein
in said process of correcting the quantization scale, correction is not performed on the quantization scale when the absolute value of the parameter does not exceed the threshold.
